(19) United States
(12) Patent Application Publication
(10) Pub. No.: US 2026/0125328 A1
(43) Pub. Date: May 7, 2026

(54) CERAMIC COMPOSITE MATERIAL AND CAPILLARY

(71) Applicant: INDUSTRIAL TECHNOLOGY RESEARCH INSTITUTE, Hsinchu (TW)

(72) Inventors: Huai-Chen YU, Taichung City (TW); Hsun-Ching HSU, Taichung City (TW); Jian-Zhi WANG, Mingjian Township (TW); Shih-Hao HUA, Sihu Township (TW)

(73) Assignee: INDUSTRIAL TECHNOLOGY RESEARCH INSTITUTE, Hsinchu (TW)

(21) Appl. No.: 18/947,047

(22) Filed: Nov. 14, 2024

(30) Foreign Application Priority Data
Nov. 1, 2024 (TW) 113141880

(51) Int. Cl. C04B 35/587

(52) U.S. Cl. CPC C04B 35/587; C04B 2235/3206; C04B 2235/3217; C04B 2235/3225; C04B 2235/3229; C04B 2235/3826; C04B 2235/3873

(57) ABSTRACT

A ceramic composite material is formed by sintering powder. The powder includes silicon nitride, silicon carbide, first metal oxide, and second metal oxide. The silicon nitride and the silicon carbide have a weight ratio of 100:0.5 to 100:12. The first metal oxide is aluminum oxide, and the second metal oxide is yttrium oxide. Alternatively, the first metal oxide may be magnesium oxide, and the second metal oxide may be cerium oxide. The ceramic composite material can be used as a capillary.

### CROSS REFERENCE TO RELATED APPLICATIONS

The present application is based on, and claims priority from, Taiwan Application Serial Number 113141880, filed on Nov. 1, 2024, the disclosure of which is hereby incorporated by reference herein in its entirety.

### TECHNICAL FIELD

The technical field relates to a ceramic composite material and capillary.

### BACKGROUND

Wire bonding is an indispensable bonding technology used in the semiconductor packaging industry for products such as ICs, LEDs, and the like.

The bonding wire is usually gold wire. Gold has good ductility, conductivity, and oxidation resistance, but it is expensive. If the gold wire is replaced with an alloy wire, the cost can be reduced by about 60%. However, the alloy wire can easily abrade the capillary due to its high hardness, and so a ceramic composite material having a higher hardness and greater flexural strength is called for, for use as the capillary.

### SUMMARY

One embodiment of the disclosure provides a ceramic composite material, formed by sintering powder, wherein the powder includes silicon nitride, silicon carbide, first metal oxide, and second metal oxide. The silicon nitride and the silicon carbide have a weight ratio of 100:0.5 to 100:12. The first metal oxide is aluminum oxide or magnesium oxide. When the first oxide is aluminum oxide, the second metal oxide is yttrium oxide. When the first oxide is magnesium oxide, the second metal oxide is cerium oxide.

One embodiment of the disclosure provides a capillary including the described ceramic composite material.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a ceramic composite material, being formed by sintering powder. The powder includes silicon nitride, silicon carbide, first metal oxide, and second metal oxide, and the silicon nitride and the silicon carbide have a weight ratio of 100:0.5 to 100:12, such as 100:0.9, 100:1, 100:2, 100:3, 100:4, 100:5, 100:6, 100:7, 100:8, 100:9, 100:10, 100:11, 100:11.5, or 100:12. If the amount of the silicon carbide is too low, the hardness of the ceramic composite material cannot be enhanced. If the amount of the silicon carbide is too high, the hardness of the ceramic composite material is lowered (compared to the ceramic composite material obtained by sintering powder without silicon carbide). In some embodiments, the powder is essentially consisting of silicon nitride, silicon carbide, first metal oxide, and second metal oxide, which is free of another general material for sintering ceramic (e.g., boron oxide, iron oxide, chromium oxide, or titanium oxide).

In some embodiments, the first metal oxide is aluminum oxide and the second metal oxide is yttrium oxide. In some embodiments, the first oxide is magnesium oxide and the second metal oxide is cerium oxide.

In some embodiments, the silicon nitride and the first metal oxide have a weight ratio of 100:3 to 100:7, such as 100:4, 100:5, or 100:6. If the amount of the first metal oxide is too low or too high, the hardness and the flexural strength of the ceramic composite material will be relatively low. In some embodiments, the silicon nitride and the second metal oxide have a weight ratio of 100:1 to 100:5, such as 100:1.5, 100:2, 100:3, or 100:4. If the amount of the second metal oxide is too low or too high, the hardness and the flexural strength of the ceramic composite material will be relatively low.

In some embodiments, the powder further includes an impurity, and the impurity includes titanium, iron, nickel, zirconium, lanthanum, or a combination thereof. The impurity mainly comes from the raw materials of the silicon nitride, silicon carbide, first metal oxide, and second metal oxide. Theoretically, the raw materials can be further purified to remove the impurity, but the purification steps may dramatically increase the cost of the ceramic composite material. On the other hand, the effects of the impurity on the properties of the ceramic composite material may be negligible, and so the raw materials are not deliberately purified to remove the impurity. It should be understood that if the commercially available raw materials are free of impurities, the ceramic composite material of the disclosure will also be free of impurities. Therefore, the ceramic composite material can be free of impurities.

In some embodiments, the silicon nitride and the impurity have a weight ratio of 100:0.01 to 100:4. If the content of the impurity is too high, the properties of the ceramic composite material (e.g., its hardness and flexural strength) will be lowered.

In some embodiments, the content of the first metal oxide is higher than the content of the impurity, and the content of the second metal oxide is higher than the content of the impurity. For example, if the content of the silicon nitride is 100 parts by weight and the content of the impurity is up to 4 parts by weight, the content of the first metal oxide must be higher than 4 parts by weight, and the content of the second metal oxide must be higher than 4 parts by weight. If the content of the first metal oxide or the content of the second metal oxide is less than the content of the impurity, the properties of the ceramic composite material (e.g., hardness and flexural strength) may be lowered.

One embodiment of the disclosure provides a capillary including the described ceramic composite material. In general, the material of the capillary for wire bonding an alloy wire should have a hardness of higher than 1800 Hv and a flexural strength of 650 MPa. In one embodiment, the capillary can be formed by injection molding as described below. Silicon nitride powder, first metal oxide powder, second metal oxide powder, and silicon carbide powder are ball milled and sieved to obtain an initial powder. The initial powder, binder, and paraffin are blended, and then dried and pelletized to form a raw material. The raw material is melted and injected into a mold, and then cooled to obtain a green body. The binder and the paraffin in the green body are removed (degreasing). The degreased green body is sintered to obtain the capillary. The injection molding process is only for illustration rather than limiting the disclosure thereto. The disclosure may use another method, and is not limited to the use of injection molding.

On the other hand, the ceramic composite material of the disclosure is mainly used as a capillary, but it is not limited thereto. The ceramic composite material can be used in other products. In other words, the ceramic composite material used as the other products may have a lower hardness (e.g., lower than 1800 Hv).

Below, exemplary embodiments will be described in detail so as to be easily realized by a person having ordinary knowledge in the art. The inventive concept may be embodied in various forms without being limited to the exemplary embodiments set forth herein.

### EXAMPLES

In following Examples, the hardness of the samples was measured according to the standard CNS 13983. In following Examples, the flexural strength of the samples was measured according to the standard CNS 12701.

### Comparative Example 1-1

93 parts by weight of silicon nitride powder and 7 parts by weight of magnesium oxide powder were mixed and then added into 50 mL of anhydrous ethanol solvent. 0.5 parts by weight of polyethylene imide (PEI, EPOMIN SP-200 commercially available from NIPPON SHOKUBAI CO., LTD.) was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene (TAIRIREX® commercially available from Formosa Chemicals and Fiber Corporation) serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1425 Hv10 and a flexural strength of 478 MPa.

The described steps of injection molding, degreasing, and sintering mainly corresponded to a process for forming a product in practice. If the injection molding process was not adopted, other steps can be used to form the product. For example, the initial powder could be directly compressed to form a bulk and then sintered, thereby omitting the binder and the paraffin. It should be understood that the properties (such as the hardness and the flexural strength) of the sample obtained by directly sintering the initial powder should be similar to those of the sample obtained by the described process (e.g., injection molding and related steps).

### Comparative Example 1-2

93 parts by weight of silicon nitride powder, 5 parts by weight of magnesium oxide powder, and 2 parts by weight of cerium oxide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1693 Hv10 and a flexural strength of 581 MPa.

### Comparative Example 1-3

93 parts by weight of silicon nitride powder, 3 parts by weight of magnesium oxide powder, and 4 parts by weight of cerium oxide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1596 Hv10 and a flexural strength of 576 MPa.

### Comparative Example 1-4

93 parts by weight of silicon nitride powder, 1 part by weight of magnesium oxide powder, and 6 parts by weight of cerium oxide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1316 Hv10 and a flexural strength of 421 MPa.

### Example 1

As shown in Comparative Examples 1-1 to 1-4, the sample obtained by sintering 93 parts by weight of silicon nitride powder, 5 part by weight of magnesium oxide powder, and 2 parts by weight of cerium oxide powder (i.e., Comparative Example 1-2) had the higher hardness and flexural strength. As such, silicon carbide powder was added to the composition of this content ratio to further adjust the properties of the sample.

93 parts by weight of silicon nitride powder, 5 part by weight of magnesium oxide powder, 2 parts by weight of cerium oxide powder, and 5 parts by weight of silicon carbide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1823 Hv10 and a flexural strength of 638 MPa.

### Comparative Example 2-1

93 parts by weight of silicon nitride powder and 7 parts by weight of aluminum oxide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1672 Hv10 and a flexural strength of 648 MPa.

### Comparative Example 2-2

93 parts by weight of silicon nitride powder, 5 parts by weight of aluminum oxide powder, and 2 parts by weight of yttrium oxide were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1812 Hv10 and a flexural strength of 674 MPa.

### Comparative Example 2-3

93 parts by weight of silicon nitride powder, 3 parts by weight of aluminum oxide powder, and 4 parts by weight of yttrium oxide were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1705 Hv10 and a flexural strength of 623 MPa.

### Comparative Example 2-4

93 parts by weight of silicon nitride powder, 1 part by weight of aluminum oxide powder, and 6 parts by weight of yttrium oxide were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1546 Hv10 and a flexural strength of 579 MPa.

### Example 2-1

As shown in Comparative Examples 2-1 to 2-4, the sample obtained by sintering 93 parts by weight of silicon nitride powder, 5 part by weight of magnesium oxide powder, and 2 parts by weight of yttrium oxide powder (i.e., Comparative Example 2-2) had the higher hardness and flexural strength. As such, silicon carbide powder was added to the composition of this content ratio to further adjust the properties of the sample.

93 parts by weight of silicon nitride powder, 5 parts by weight of aluminum oxide powder, 2 parts by weight of yttrium oxide, and 1 part by weight of silicon carbide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1892 Hv10 and a flexural strength of 703 MPa.

### Example 2-2

93 parts by weight of silicon nitride powder, 5 parts by weight of aluminum oxide powder, 2 parts by weight of yttrium oxide, and 5 parts by weight of silicon carbide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 2460 Hv10 and a flexural strength of 762 MPa.

### Example 2-3

93 parts by weight of silicon nitride powder, 5 parts by weight of aluminum oxide powder, 2 parts by weight of yttrium oxide, and 10 parts by weight of silicon carbide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1832 Hv10 and a flexural strength of 678 MPa.

### Comparative Example 2-5

93 parts by weight of silicon nitride powder, 5 parts by weight of aluminum oxide powder, 2 parts by weight of yttrium oxide, and 15 parts by weight of silicon carbide powder were mixed and then added into 50 mL of anhydrous ethanol solvent. 0.5 parts by weight of PEI was then added to the solvent to serve as a dispersant. The mixture was put into a ball mill pot. Tungsten carbide milling balls having a diameter of 10 mm were put into the ball mill pot to perform ball milling and mixing for 8 hours. The mixture was then put into an oven at 120° C. until the powder was completely dried, and then ground and sieved to obtain an initial powder with a uniform particle size.

80 parts by weight of the initial powder, 15 parts by weight of polystyrene serving as a binder, and 5 parts by weight of paraffin were evenly blended, and then dried and pelletized to form an injection molding raw material with a high flowability. The raw material was melted and then injected into a mold, and then cooled and cured to obtain a green body. The green body was dipped in n-octane for 4 hours to remove most of the paraffin and the binder in the green body. Thereafter, the green body was heated by a degreasing furnace for 6 hours to thermally decompose the residual paraffin and binder in the green body (degreasing). The degreased green body was heated to 1800° C. under a nitrogen atmosphere and sintered for 12 hours to obtain a sample. The sample had a hardness of 1657 Hv10 and a flexural strength of 646 MPa. Accordingly, adding too much silicon carbide would lower the hardness and the flexural strength of the sample.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A ceramic composite material, being formed by sintering powder,
wherein the powder comprises silicon nitride, silicon carbide, first metal oxide, and second metal oxide, the silicon nitride and the silicon carbide have a weight ratio of 100:0.5 to 100:12, and the first metal oxide is aluminum oxide or magnesium oxide, wherein
when the first oxide is aluminum oxide, the second metal oxide is yttrium oxide; and
when the first oxide is magnesium oxide, the second metal oxide is cerium oxide.

2. The ceramic composite material as claimed in claim 1, wherein the silicon nitride and the first metal oxide have a weight ratio of 100:3 to 100:7.

3. The ceramic composite material as claimed in claim 1, wherein the silicon nitride and the second metal oxide have a weight ratio of 100:1 to 100:5.

4. The ceramic composite material as claimed in claim 1, wherein the powder further comprises an impurity, and the impurity comprises titanium, iron, nickel, zirconium, lanthanum, or a combination thereof.

5. The ceramic composite material as claimed in claim 4, wherein the silicon nitride and the impurity have a weight ratio of 100:0.01 to 100:4.

6. The ceramic composite material as claimed in claim 4, wherein a content of the first metal oxide is higher than a content of the impurity, and a content of the second metal oxide is higher than the content of the impurity.

7. A capillary, comprising the ceramic composite material as claimed in claim 1.
